(19) United States
(12) Patent Application Publication
(10) Pub. No.: US 2007/0226381 A1
(43) Pub. Date: Sep. 27, 2007

(54) Computer system capable of detecting identification of peripheral device connected thereto and method of detecting identification of peripheral device using the same

(75) Inventors: Chi-Chang Kuan, Taipei County (TW); Chiu-Ming Ho, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: Askey Computer Corporation, Taipei (TW)

(21) Appl. No.: 11/525,919

(22) Filed: Sep. 25, 2006

(30) Foreign Application Priority Data
Jan. 27, 2006 (TW) 95202093

(51) Int. Cl. G06F 3/00

(52) U.S. Cl. 710/16

(57) ABSTRACT

A computer system capable of detecting an identification (ID) of a peripheral device connected thereto includes a connection circuit having a peripheral interface connectable to the peripheral device and a data transmission interface for data transmission between the peripheral device and a CPU of the computer system, a detect circuit connected to the connection circuit and a DC voltage source of the computer system, and a convert unit. The detect circuit has an output terminal set and a plurality of resistors having resistances for producing a specific DC potential divided by the DC voltage source at the output terminal set. The convert unit is coupled to the output terminal set and the CPU for converting the specific DC potential at the output terminal set into a digital signal corresponding to the ID of the peripheral device for output to the CPU.

### BACKGROUND OF THE INVENTION

1. Field of the Invention

The present invention relates to peripheral input/output devices of a computer system and more particularly, to a computer system, such as a personal digital assistant (PDA), capable of detecting the identification (ID) of a peripheral device connected thereto. The present invention also relates to a method of detecting the ID of a peripheral device by using the computer system.

2. Description of the Related Art

The peripheral device of a computer system, for example, an input device such as keyboard or mouse, and other portable device with interface of USB (Universal Serial Bus) or PCMCIA (Personal Computer Memory Card International Association), is designed to communicate with the central processing unit (CPU) for signal transmission by means of a convert circuit that may be directly mounted inside the computer system or the peripheral device to convert transmission signal between the peripheral device and the CPU for data exchange. The convert circuit may be directly coupled to the CPU or alternatively to a control chipset that is bridged to the CPU. FIG. 1 shows a conventional computer system 1, which comprises a chipset 10, a GPIO (General Purpose Input/Output) interface 101 mounted inside the chipset 10, an interfaced bus 11, a plurality of converters 12, and a plurality of peripheral devices 13 and 14. The chipset 10 can be an integrated chipset integrating the north bridge integrated circuit (IC) and south bridge IC with the CPU. Alternatively, the chipset 10 can be a south bridge IC bridging to the CPU. The chipset 10 is coupled to I/O components through the GPIO interface 101. The interfaced bus 11 is adapted to fan out the GPIO interface 101 as a plurality of GPIO ports 111 that can be respectively connected to a GPIO port 120 of each of the converters 12 and a GPIO port 130 of each of the peripheral devices 13. The converters 12 have compatible peripheral devices 14 connected thereto. Each of the peripheral devices 13 and the converters 12 has a respective convert circuit that is the same as the aforesaid convert circuit. By means of the GPIO interface 101, the CPU identifies the ID of the peripheral device 13 or 14 so as to drive the corresponding control circuit, for enabling the transmission signal of the peripheral device to be converted into readable data to the CPU. Thus, data exchange between the peripheral device 13 or 14 and the CPU is realized.

Following fast development of technology, various peripheral applications have been continuously created. When a computer system needs to use a variety of peripheral devices alternatively, added pin counts must be provided to every GPIO port so as to increase the address space capable of identifying more peripheral devices. In case the occupation of an additional circuit space is acceptable, GPIO interface circuit can directly be added to a personal computer to extend the GPIO interface of the CPU or control chipset. However, this method is not applicable to a small computer system like PDA (Personal Digital Assistant). No doubt, adding the GPIO interface circuit to a PDA takes a certain part of circuit space. Technically, it is also not practical to change the existed design of the CPU or control chipset in order to increase GPIO pin counts. Further, increasing the address space for device identification causes the CPU to spend more time in searching the corresponding control circuit within the control chipset that can drive the convert circuit. This measure wastes memory resources also takes the whole circuit system more standby time, thereby increasing system power dissipation.

In view of the aforesaid problem, the PDA 2 shown in FIG. 2 is created. According to this design, the PDA 2 comprises a CPU 20, a chipset 21, a GPIO interface 210 installed in the chip set 21, a storage memory 22, a connector 23, and a GPIO port 230 and a peripheral interface 231 installed in the connector 23. The chipset 21 is an integrated chipset integrating the north bridge IC and south bridge IC, bridging to the CPU 20 and coupling to I/O components through the GPIO interface 210. The memory 22 is a nonvolatile memory device such as flash memory, EPROM, or EEPROM, storing IDs of many types of the peripheral devices. When using the PDA 2 with a peripheral device, the peripheral device is connected to the peripheral interface 231 of the connector 23, and the GPIO port 230 of the connector 23 is connected to the GPIO interface 210. At this time, the CPU 20 reads in the stored IDs from the memory 22 for comparison. After having identified the ID of the peripheral device, the CPU 20 enables the control circuit to drive the peripheral device. This method of using an extra storage memory accelerates peripheral device ID recognition and lowers system circuit standby time; however, the extra storage memory requires an extra installation space, thereby enlarging the small-sized portable computer system.

There is also known another prior art PDA 3 as shown in FIG. 3. According to this design, a storage memory 24 is directly mounted inside a connector 25. By means of a GPIO interface 250 of the connector 25, the CPU 20 proceeds with the aforesaid action. This design saves much memory installation space for the mainframe. However, the use of the storage memory 24 in the connector 25 requires more installation space for the peripheral component and greatly increases the cost. To the user-end, this design does not reduce the total space of the whole system.

### SUMMARY OF THE INVENTION

The present invention has been accomplished under the circumstances in view. It is therefore an object of the present invention to provide a computer system that detects the ID of the installed peripheral device rapidly and requires small circuit space, thereby effectively lowering power dissipation of the circuit system and saving the manufacturing cost.

To achieve this object of the present invention, the computer system comprises a connection circuit, a detect circuit, and a convert unit. The connection circuit comprises a peripheral interface connectable to a peripheral device, and a data transmission interface, compatible to the specification of data transmission with the CPU (Central Processing Unit) of the computer system, for signal transmission between the peripheral device and the CPU. The detect circuit comprises a connection terminal set connectable to the connection circuit, an output terminal set, a power terminal set coupled to a DC voltage source of the computer system, a first resistor electrically connected between the power terminal set and the output terminal set, and a second resistor electrically connected between the connection terminal set and the output terminal set. Each of the first resistor and the second resistor has a respective specific resistance for transmission of electric signal and for forming a specific DC potential divided by the DC voltage source at the output terminal set. The convert unit has an input terminal set coupled to the output terminal set, and a transmission terminal set coupled to the CPU of the computer system. The convert unit is adapted to convert the electric signal of the DC potential of the output terminal set into a digital signal for output to the CPU, thereby the CPU starts a specific control circuit to drive the peripheral device. Such digital signal corresponds to the ID (Identification) of the peripheral device that is connected to the peripheral interface.

The present invention also provides a method of detecting an identification (ID) of a peripheral device by using the aforesaid computer system. The method comprises the steps of a) connecting the peripheral device to the peripheral interface of the computer system, b) outputting a specific DC potential corresponding to a specific resistance which corresponds to the peripheral device and is formed at the connection terminal set of the detect circuit from the output terminal set to the convert unit, c) converting the specific DC potential into a digital signal corresponding to the ID of the peripheral device by the convert unit, and d) outputting the digital signal from the convert unit to the CPU for enabling the CPU to enable the control circuit for controlling the peripheral device to have transmission signal of the peripheral device be converted into readable data for data exchange with the CPU.

### BRIEF DESCRIPTION OF THE DRAWINGS

FIG. 1 is a schematic drawing showing the connection between a computer system and a peripheral device according to the prior art.

FIG. 2 is a circuit block diagram of a PDA according to the prior art.

FIG. 3 is a circuit block diagram of another design of PDA according to the prior art.

FIG. 4 is a circuit block diagram of a PDA system in accordance with a first preferred embodiment of the present invention.

FIG. 5 is a schematic block diagram of the PDA system in accordance with the first embodiment of the present invention.

FIG. 6 is a circuit block diagram of a PDA system in accordance with a second preferred embodiment of the present invention.

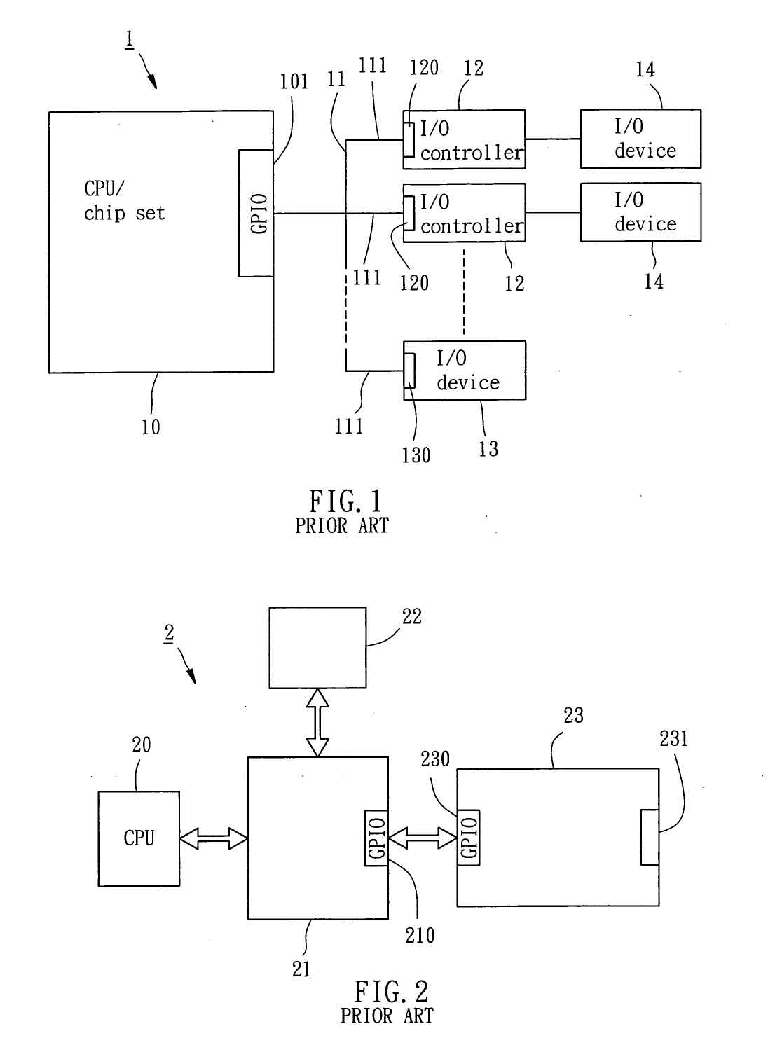

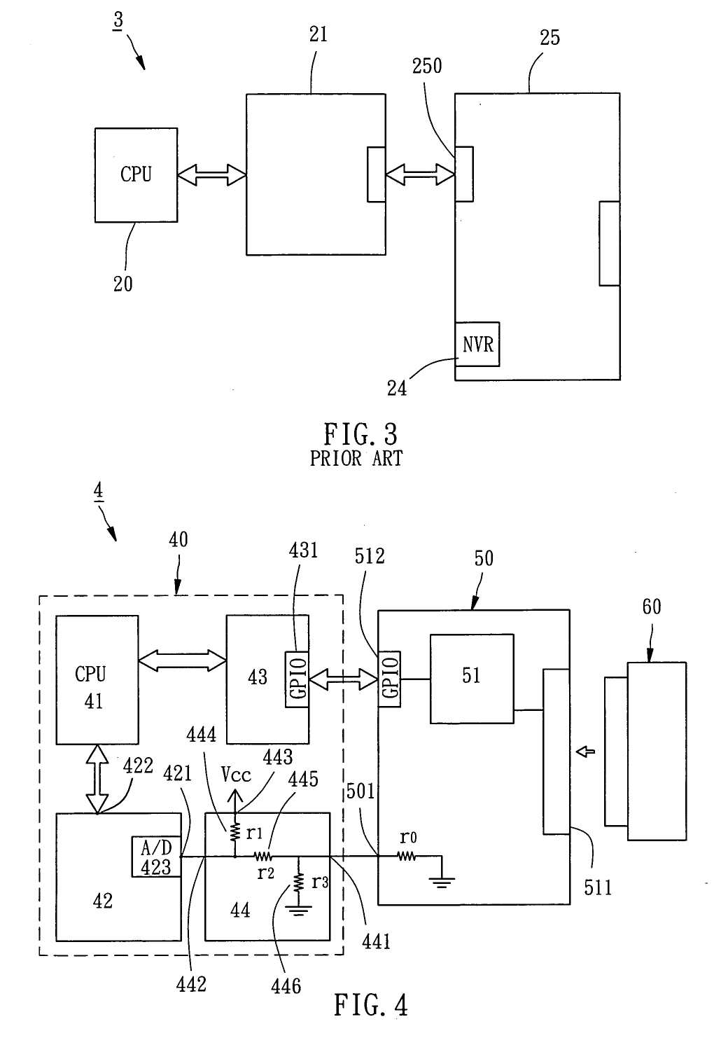

### DETAILED DESCRIPTION OF THE INVENTION

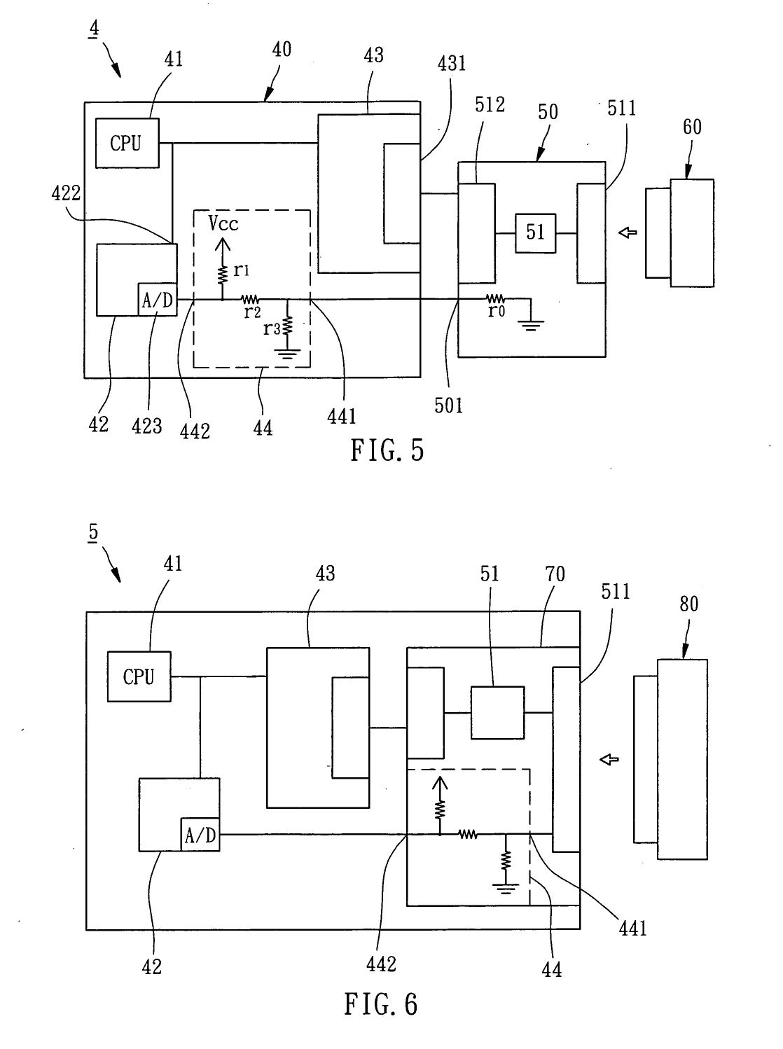

Referring to FIGS. 4 and 5, a computer system 4 in accordance with a first preferred embodiment of the present invention is shown comprising a mainframe 40, and a portable connector 50. According to this embodiment, the computer system 4 is embodied as a PDA (Personal Digital Assistant) for illustrative purpose. The mainframe 40 comprises a CPU (Central Processing Unit) 41, a convert unit 42, a control chipset 43, and a detect circuit 44. The portable connector 50 comprises a connection circuit 51 electrically connectable to a compatible peripheral device 60.

The CPU 41 provides normal operation of various circuits. The CPU 41 accesses memory data through the convert unit 42 and exchange data with the peripheral device 60 through the control chipset 43.

The convert unit 42 comprises an input terminal set 421, a transmission terminal set 422, and an ADC (Analog to Digital Converter) 423. The input terminal set 421 is coupled to the detect circuit 44, and the transmission terminal set 422 is coupled to the CPU 41. The ADC 423 is adapted to convert equivalent DC potential of the input terminal set 421 into a specific data, enabling the convert unit 42 to produce a digital signal subject to such data for output through the transmission terminal set 422.

The control chipset 43 is connectable with various interfaces of control circuits for enabling the computer system 4 to use various peripheral devices 60 compatible to the interfaces respectively. The control chipset 43 has a GPIO (General Purpose Input/Output) interface 431 for connection to the connection circuit 51 of the portable connector 50. The control chipset 43 is the medium that controls data exchange between the CPU 41 and the connected peripheral device 60.

The detect circuit 44 has a connection terminal set 441, an output terminal set 442, a power terminal set 443, a first resistor 444 electrically connected between the power terminal set 443 and the output terminal set 442, a second resistor 445 electrically connected between the connection terminal set 441 and the output terminal set 442, and a third resistor 446 that is electrically connected between the connection terminal set 441 and a zero potential. The connection terminal set 441 is for connection to the portable connector 50. The output terminal set 442 is coupled to the input terminal set 421 of the convert unit 42. The power terminal set 443 is for connection to the DC voltage source Vcc of the computer system 4. The resistors 444, 445, 446 have respective specific resistances r1, r2, r3 for producing a specific DC potential divided by the DC voltage source Vcc at the output terminal set 442.

The portable connector 50 further comprises a detect terminal set 501 coupled to the connection circuit 51 for outputting the equivalent output resistance r0 of the portable connector 50. The detect terminal set 501 is for connection to the connection terminal set 441 of the detect circuit 44. The connection circuit 51 further has a peripheral interface 511 and a data transmission interface 512. The peripheral interface 511 is electrically connectable to the peripheral device 60. The data transmission interface 512 is electrically connectable to the GPIO port of the GPIO interface 431. The connection circuit 51 is for converting the transmission signal of the peripheral device 60 into readable data to the CPU 41 for data exchange.

When using the computer system 4 with the peripheral device 60, connect the peripheral device 60 to the peripheral interface 511 of the portable connector 50 as shown in FIG. 5, and then connect the GPIO interface 431 and connection terminal set 441 to the data transmission interface 512 and the detect terminal set 501 of the portable connector 50 respectively. At this time, the detect circuit 44 of the mainframe 40 detects the output resistance of the detect terminal set 501. Because the equivalent resistance of the connection terminal set 441 is the parallel resistance of r3 and r0, the DC potential at the output terminal set 442 is: {Vcc*[r2+(r3∥r0)]/[r1+r2+(r3∥r0)]}. Thereafter, the convert unit 42 drives the ADC 423 to convert the DC potential into a specific data, thereby producing a digital signal corresponding to the ID of the peripheral device 60 for output to the CPU 41 through the transmission terminal set 422. Upon receipt of the digital signal, the CPU 41 starts a specific control circuit of the control chipset 43 to drive the peripheral device 60 and to have the transmission signal of the peripheral device 60 be converted into readable data by means of the connection circuit 51 for data exchange with the CPU 41. Therefore, the invention eliminates the use of an extra storage memory, saving much production cost. By means of digital processing of the convert unit 42 to recognize the ID of the peripheral device 60 in advance, and then starting the specific control circuit of the control chipset 43 by the CPU 41, the design of the present invention effectively lowers power dissipation of the whole circuit system.

FIG. 6 shows a computer system 5 in accordance with a second embodiment of the present invention. According to this embodiment, the computer system 5 is a PDA (Personal Digital Assistant). The circuit architecture of this embodiment is a single mainframe structure comprising a CPU (Central Processing Unit) 41, a convert unit 42, a control chipset 43, and a connection module 70.

The connection module 70 is an integral circuit module of the aforesaid detect circuit 44 and connection circuit 51, wherein the connection terminal set 441 of the detect circuit 44 is coupled to the peripheral interface 511 of the connection circuit 51.

When using the PDA 5 with a peripheral device 80, the connection terminal set 441 of the detect circuit 44 detects the effective resistance of the peripheral interface 511. Therefore, a specific DC potential is produced at the output terminal set 442, for enabling the ID (Identification) of the peripheral device 80 to be produced through the convert unit 42 so that the CPU 41 can start a specific control circuit of the control chipset 43 to drive the peripheral device 80. The PDA 5 according to this second embodiment has the connection circuit 51 built in the connection module 70. This second embodiment achieves the same effect as the aforesaid first embodiment while saving the fabrication of the portable connector and making the system highly portable.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A computer system comprising:
a connection circuit having a peripheral interface connectable to a peripheral device having an identification (ID), and a data transmission interface for connection to a central processing unit (CPU) of the computer system for signal transmission;
a detect circuit having a connection terminal set electrically connected to said connection circuit, an output terminal set, a power terminal set coupled to a direct current (DC) voltage source of the computer system, a first resistor electrically connected between said power terminal set and said output terminal set, and a second resistor electrically connected between said connection terminal set and said output terminal set, said first resistor and said second resistor each having a respective specific resistance for transmission of electric signal and for forming a specific DC potential divided by the DC voltage source at said output terminal set; and
a convert unit having an input terminal set coupled to said output terminal set, and a transmission terminal set coupled to the CPU of the computer system;
wherein said convert unit converts the specific DC potential at said output terminal set to a digital signal corresponding to the ID of the periphery device that is connected to said peripheral interface and outputs the digital signal through said output terminal set.

2. The computer system as claimed in claim 1, which is a personal digital assistant (PDA).

3. The computer system as claimed in claim 2, further comprising a control chipset electrically connected to the CPU of the computer system, said control chipset having a general purpose input/output (GPIO) interface.

4. The computer system as claimed in claim 3, wherein said data transmission interface of said connection circuit is electrically connected to said GPIO interface.

5. The computer system as claimed in claim 1, wherein said convert unit comprises an analog to digital converter (ADC) for converting the specific DC potential at said output terminal set of said detect circuit into a specific data.

6. The computer system as claimed in claim 5, wherein said convert unit converts said specific data into said digital signal corresponding to the ID of the peripheral device.

7. The computer system as claimed in claim 1, wherein said detect circuit further comprises a third resistor that is connected between said connection terminal set and a zero potential.

8. The computer system as claimed in claim 1, further comprising a portable connector provided with said connection circuit, said portable connector having an detect terminal set coupled to said connection circuit for output of an equivalent output resistance of said portable connector.

9. The computer system as claimed in claim 8, wherein said detect terminal set is connected to said connection terminal set; said detect terminal set and said connection terminal set have an equal potential.

10. The computer system as claimed in claim 1, further comprising a connection module provided with said connection circuit and said detect circuit; wherein the connection terminal set of said detect circuit is electrically connected to the peripheral interface of said connection circuit.

11. A method of detecting an identification of a peripheral device, comprising the steps of:
a) connecting the peripheral device to a peripheral interface of a computer system having a connection device, a detect circuit and a convert unit;
wherein the connection device has the peripheral interface and a data transmission interface for connection to a central processing unit (CPU) of the computer system for signal transmission;
wherein the detect circuit is electrically connected to a direct current (DC) voltage source of the computer system and has a connection terminal set electrically connected to the connection device and an output terminal set electrically connected to the convert unit;
wherein the convert unit is electrically connected to the CPU of the computer system;
b) outputting a specific DC potential corresponding to a specific resistance which corresponds to the peripheral device and is formed at the connection terminal set of the detect circuit from the output terminal set to the convert unit;
c) converting the specific DC potential into a digital signal corresponding to the ID of the peripheral device by the convert unit; and
d) outputting the digital signal from the convert unit to the CPU for enabling the CPU to enable a control circuit for controlling the peripheral device to have transmission signal of the peripheral device be converted into readable data by the connection device for data exchange with the CPU.

12. The method as claimed in claim 11, wherein the data transmission interface of the connection device is electrically connected to a general purpose input/output (GPIO) interface of the computer system in step a).

13. The method as claimed in claim 12, wherein the connection device is a portable connector having a detect terminal set electrically connected to the connection terminal set of the detect circuit; wherein the method further comprises a step of outputting an equivalent resistance of the portable connector from the detect terminal set before step b).
